(19) United States
(12) Patent Application Publication
(10) Pub. No.: US 2006/0243372 A1
(43) Pub. Date: Nov. 2, 2006

(54) Method for the coating of work pieces

(75) Inventor: Reinhard Huber, Freudenstadt (DE)

Correspondence Address: VOLPE AND KOENIG, P.C., UNITED PLAZA, SUITE 1600, 30 SOUTH 17TH STREET, PHILADELPHIA, PA, 19103, US

(73) Assignee: Robert Burkle GmbH, Freudenstadt (DE)

(21) Appl. No.: 11/406,551

(22) Filed: Apr. 19, 2006

(30) Foreign Application Priority Data
May 2, 2005 (DE) 10 2005 020 852.5

(51) Int. Cl. B32B 37/00

(52) U.S. Cl. 156/152; 264/510; 156/285

(57) ABSTRACT

A method for a multi-sided coating of work pieces with film is provided, in which the work pieces are put on a lower press component, subsequently the film is inserted into the press gap above the work pieces, the press is closed, and the film is heated from above. The film is briefly lifted off the upper sides of the work pieces and kept suspended prior to adherence.

### BACKGROUND

The invention relates to a method for a multi-sided coating of work pieces with a film, in particular of furniture pieces, at their upper side and lateral side surfaces, with the work pieces being put onto a lower press component, if necessary via a pallet, subsequently the film is inserted into the press gap above the work pieces, the press is closed, and the film is heated from above, with the film contacting the upper side of the work pieces and, after having reached a predetermined temperature range, is pressed and thus adhered by pressure from above and/or a vacuum from below not only to the upper sides but to the lateral side surfaces of the inserted work pieces as well.

The primary use of the invention is the coating of three-dimensional furniture components, which are to be coated with a plastic film, a veneer, or the like not only at their front but also at the peripheral lateral side surfaces. In the following, only a film is referenced; however, this is without limitation as to the scope of the invention and “film” is intended to refer to any coating material suitable for this type of installation. The coating occurs by the use of heat and pressure in a press, with usually several work pieces being inserted simultaneously into the press in order to optimally use its capacity. Here, the work pieces can be fed to the press via a pallet and be put onto the lower press component, which usually is provided with a special support system, after which they are coated simultaneously. After having left the press the work pieces are separated by cutting them from the connected film.

In order for the plastic film to have good contact and to be bonded not only to the upper sides of the work pieces but also to the lateral side surfaces recessing, in particular at their lower edges, the work pieces need to be spaced from their support. This occurs either by spacer pieces, which are inserted under each work piece with a recess in reference to an exterior contour of the piece, or by support pins in the form of lifting pins, which displace into the upper position and this way raise the work pieces. In both cases, the lower exterior edge of the work pieces become free and the film can be attached there. Examples for support systems with lifting pins are described in DE 197 18 561 and DE 198 36 219, which are by the same applicant. Certainly, other support systems may also be used instead.

In order for the coating of the upper side, the lateral surfaces, and the edges to occur wrinkle-free and evenly it is recommended for the film not to be suspended freely during the heating process but to be supported on the upper side of the work pieces. This way, the work pieces are heated also at the upper side to a certain extent and the difference in temperature between the film and the work pieces is reduced. Therefore the film is better able to elastically compensate the expansion differences between the upper side of the work piece and the lateral surfaces of the work piece without causing any wrinkles.

Examinations by the applicant have shown however that the previously known coating methods are problematic when high-gloss films are used. These films tend to lose some of their gloss and/or to produce unsatisfactory coating qualities at the lateral surfaces.

### SUMMARY

The object of the present invention is therefore to improve the known coating methods such that even sensitive films, in particular high-gloss films, result in flawless coatings.

This objective is attained according to the invention in that the film is at least partially lifted from the upper sides of the work pieces prior to the adhesion to the lateral surfaces of the work pieces and held suspended.

Using this measure, surprisingly the coating quality, in particular in high-gloss films, can be considerably improved. According to the knowledge of the applicant, this is caused by the following: Here, by attaching the film to the upper side of the work piece during the heating process a considerably lower film temperature develops in reference to the one of the areas, in which the film is not contacting the work pieces. This difference in temperature in the film appears to cause the entire quality problem mentioned. It is considerably reduced by lifting the film off the upper side of the work pieces, because the lifted film sections cannot transfer any heat to the work piece and simultaneously they are positioned closer to the heater.

Although the same effect could be achieved in constantly keeping the film at a distance from the work pieces during the heating process; however, when lowering the film onto the cold work pieces a shock process would occur, which is disadvantageous for the coating quality according to the examinations of the applicant. However, the brief lifting of the film results in the work pieces to be preheated and the differences in temperature between the film sections contacting the work pieces and the film sections without any contact to work pieces could be reduced. This results in a high-gloss film surface with a simultaneously well formed lateral surface.

The desired lifting of the film can be realized by different structural means. It is particularly beneficial for the film to be impinged by pressure at the bottom side and/or vacuum at the upper side. However, the scope of the invention also includes lifting the film by mechanical forces, either by lifting fasteners holding the edge of the film or by stretching the film to a level above the upper side of the work pieces.

The length of time the film remains lifted, partially or entirely, largely depends on the process parameters, in particular the temperature control and the distance that the film is separated from the heating element after lifting. It is beneficial for the lower value of this duration to amount to at least 3 seconds. It has shown that frequently this is sufficient to achieve the desired reheating of the film sections previously cooled by the work pieces.

However, the scope of the invention also includes for the film to be impinged with hot air from the bottom and thus to accelerate the temperature equalization within the film.

Beneficially, the heating of the film from above occurs without contact by radiation. In this case, it is recommended for the film to spaced at a distance from the upper heating element even in the lifted stage, because otherwise the radiation temperature results in overheating the film.

When the heating of the film occurs by way of contact at a heating plate, though, the heating place certainly must perform a lifting motion as well, in order to allow the lifting of the film off the work pieces.

The time for lifting the film can also be varied. It is particularly beneficial for the film to be lifted at the end of the heating phase and for the pressing of the film onto the upper side and the lateral surfaces of the work piece to occur immediately thereafter.

However, the scope of the invention also includes the use of not a single lifting motion but several subsequent lifting motions in order to reduce the development of differences in temperatures from the very beginning.

In general, however, the film should be pressed precisely to the upper side of the work piece during the heating phase, in order to be provided here with a lower temperature than in the areas, in which the film does not contact the work pieces.

### BRIEF DESCRIPTION OF THE DRAWINGS

Additional features and advantages of the invention are discernible from the following description of an exemplary embodiment and from the drawing; which show:

FIG. 1 is a general view of the press for performing the method according to the invention;

FIG. 2 is an enlarged section view of the press components forming the press gap, in a vertical cross-section;

FIG. 3 is the same vertical cross-section as shown in FIG. 2 in a second stage of the method;

FIG. 4 is the same vertical cross-section as shown in FIG. 2 in a third stage of the method, and

FIG. 5 is the same vertical cross-section as shown in FIG. 2 in a fourth stage of the invention.

### DETAILED DESCRIPTION OF THE PREFERRED EMBODIMENTS

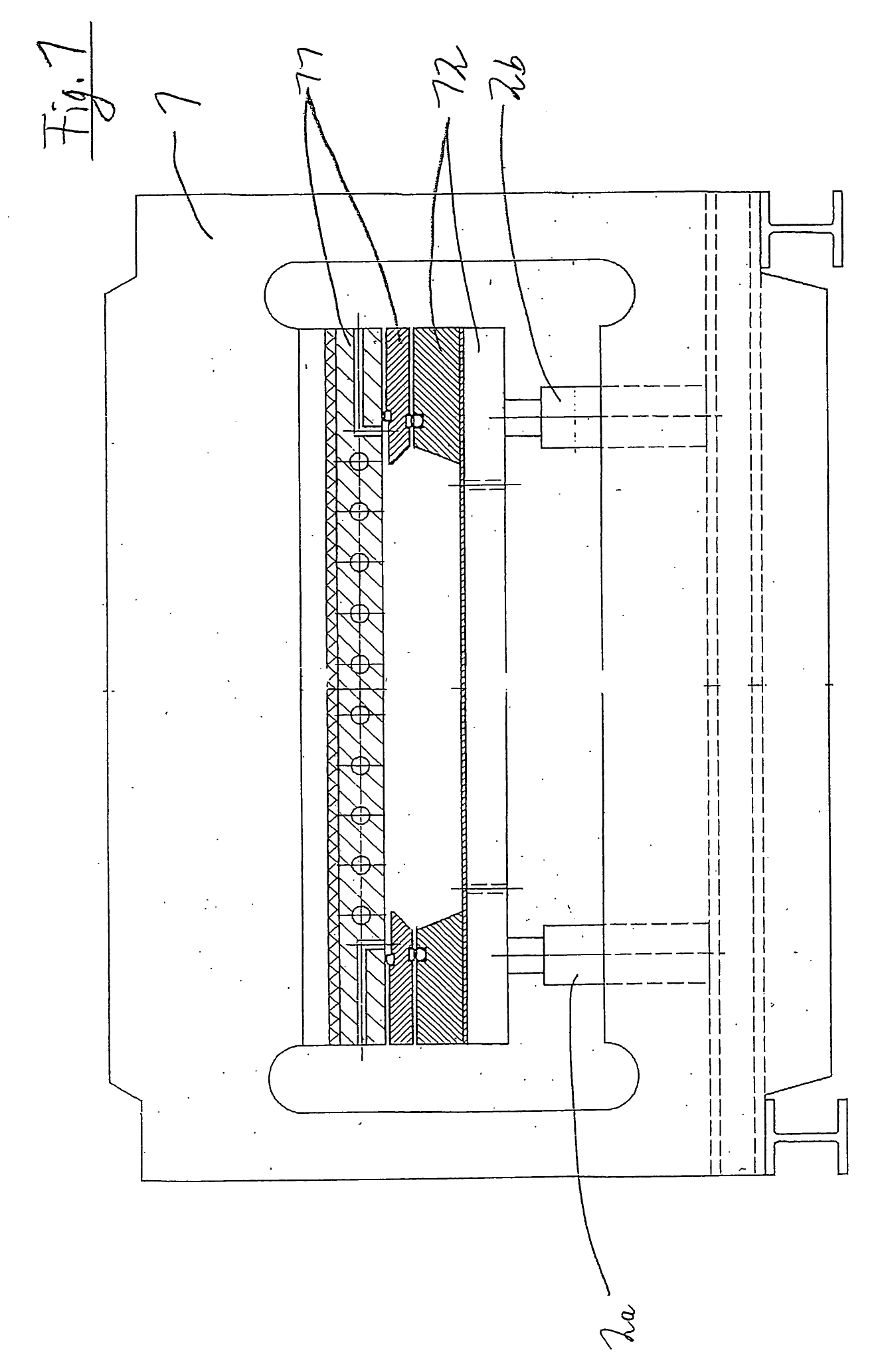

FIG. 1 shows an overview of the press for performing the method according to the invention. The press comprises a press frame 1, at which an upper press component 11 is mounted. The lower press component 12 is connected to the press frame 1 by two pressure cylinders 2a and 2b. By expanding and contracting the pressure cylinders 2a and 2b the distance between the lower press component 12 and the upper press component 11 can be changed and the lower press component can be pressed against the upper press component.

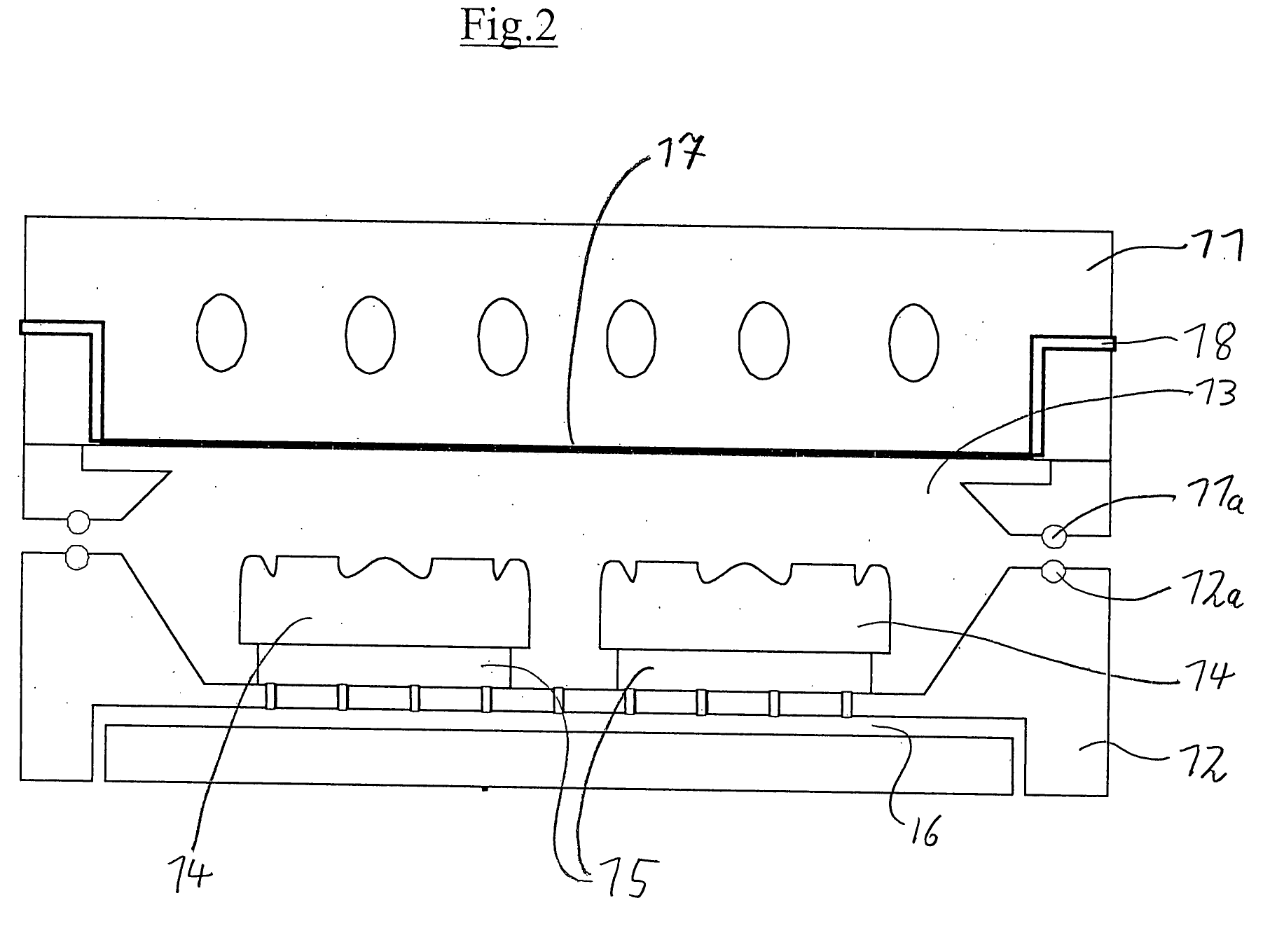

FIGS. 2 through 5 each show the upper press component 11 and the lower press component 12 in an enlarged representation. In the closed together position, both press components form a hollow space 13 for accepting the work pieces 14 to be coated. The work pieces 14 are supported on the support plates 15, each of which is recessed in reference to the edge contour of the work pieces 14. This way, the work pieces can also be coated easily at their lateral surfaces, in particularly at their lower edges.

Instead of the support plates 15 shown, it is also possible to support the work pieces on lifting pins, which can be displaced into the upper position and thus lift the work pieces into the coating position shown. Such lifting pins remain in the lower resting position when they are not covered by a work piece, in order to prevent any interference with the coating process at the lateral edge surfaces of the work pieces. Alternatively, adjustable support pints can be used too, which can be displaced such that they are each located below a work piece 14.

Furthermore, in FIGS. 2 through 5 it is discernible that the lower press component 12 is provided with a channel system 16, which connects the hollow space 13 to a pressure or vacuum source, not shown.

The upper press component 11 essentially works as a heating plate, which is heated electrically or by any other means. At its bottom side it is provided with a black radiating plate 17, for good heat conduction, which is provided over its entire cross-section with an almost even temperature.

Finally, the upper press component 11 is also provided with a channel system 18 in order to allow the hollow space 13 to be impinged with a pressure or a vacuum from above.

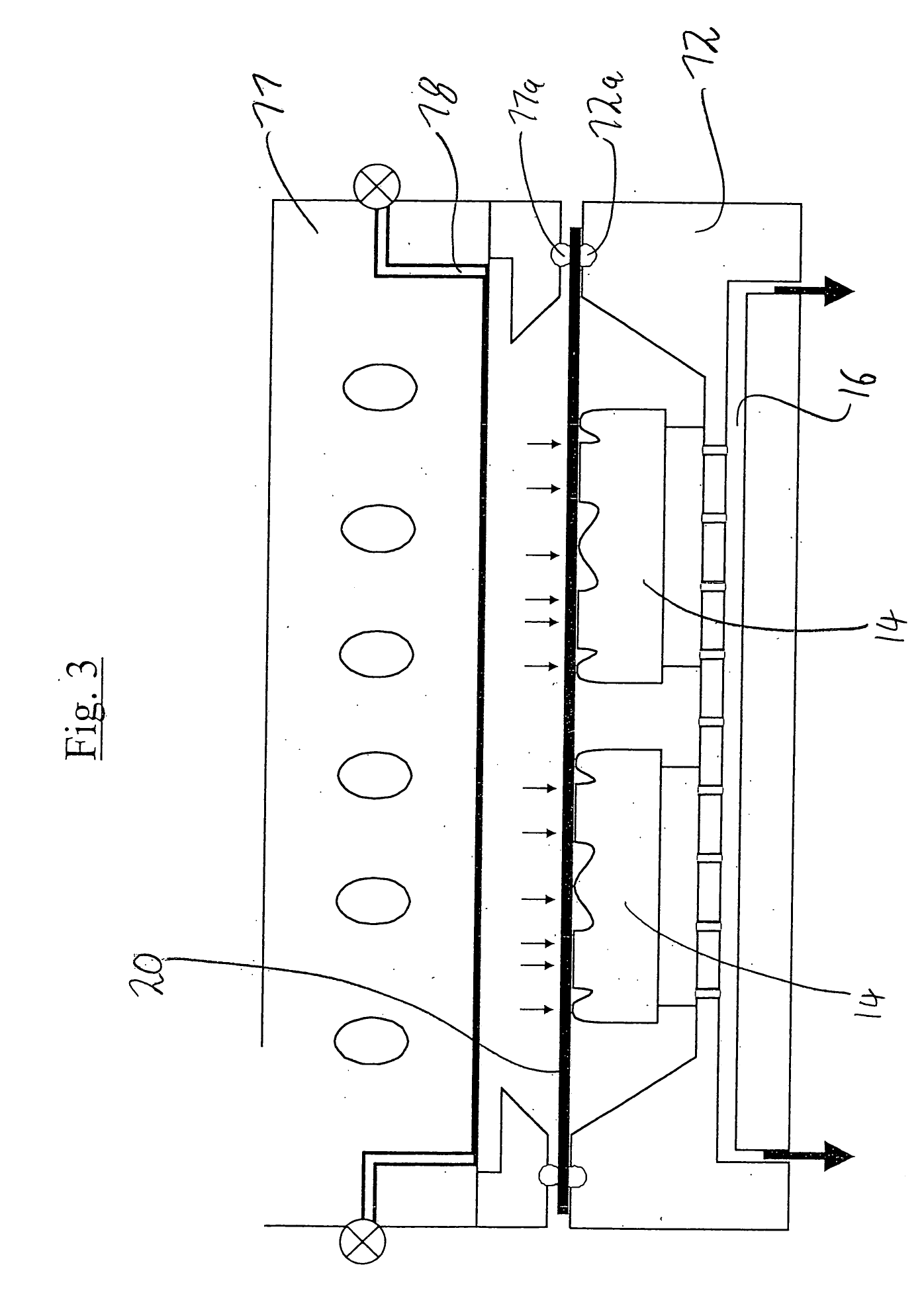

FIG. 2 shows the processing stage, in which the work pieces 14 have already been inserted into the originally wide open press gap and the upper press component and the lower press component are subsequently to be brought closely together. Prior to the closing, the coating film is inserted into the press gap. Subsequently the press is closed. This stage is shown in FIG. 3. Here, the coating film 20 is discernible, which is held at its edges by sealing frame 11a and/or 12a arranged between the upper press component and/or the lower press component. In its central section the film 20 is loosely supported on the work pieces 14, though. In this processing stage the heating of the film occurs. In order to cause a predetermined heat transfer from the film to the work pieces 14 it is preferred to press the film against the work pieces either by a slight vacuum in the channel system 16 or by a slight pressure in the channel system 18.

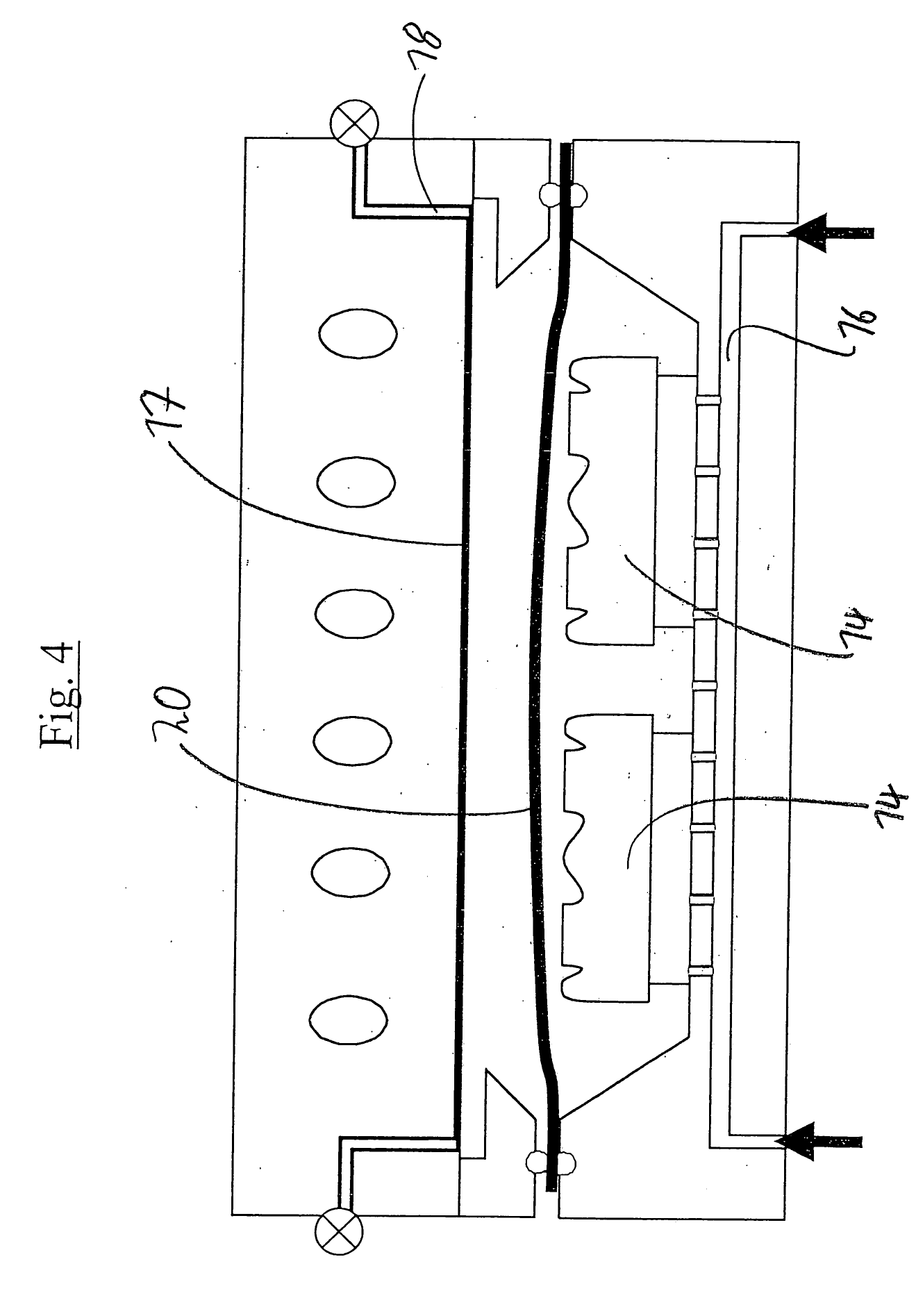

When the film 20 has reached the desired temperature, so that the layer of adhesive applied to the bottom of the film begins to become reactive or prior to reaching said temperature, the processing step according to FIG. 4 of the invention is initiated, namely a brief lifting of the film 20 off the work pieces 14, without the film contacting the heating surface 17, though. This lifting advantageously occurs by impinging pressure via the lower channel system 16, as indicated in FIG. 4. However, the scope of the invention also includes for the upper channel system 18 instead of or additionally to apply a vacuum to the hollow space positioned above the film 20.

The lifting of the film 20 off the work pieces 14 advantageously occurs in a time ranging from approximately 5 seconds to approximately 10 seconds. This is sufficient for the strongly varying temperatures between the film sections that previously had been in contact to the work pieces 14 and the adjacent film sections to be equalized to some extent. Thus, the temperature change between the two sections mentions occurs less abruptly, which has proven very beneficial for the subsequent deformation, in particular in high-gloss films.

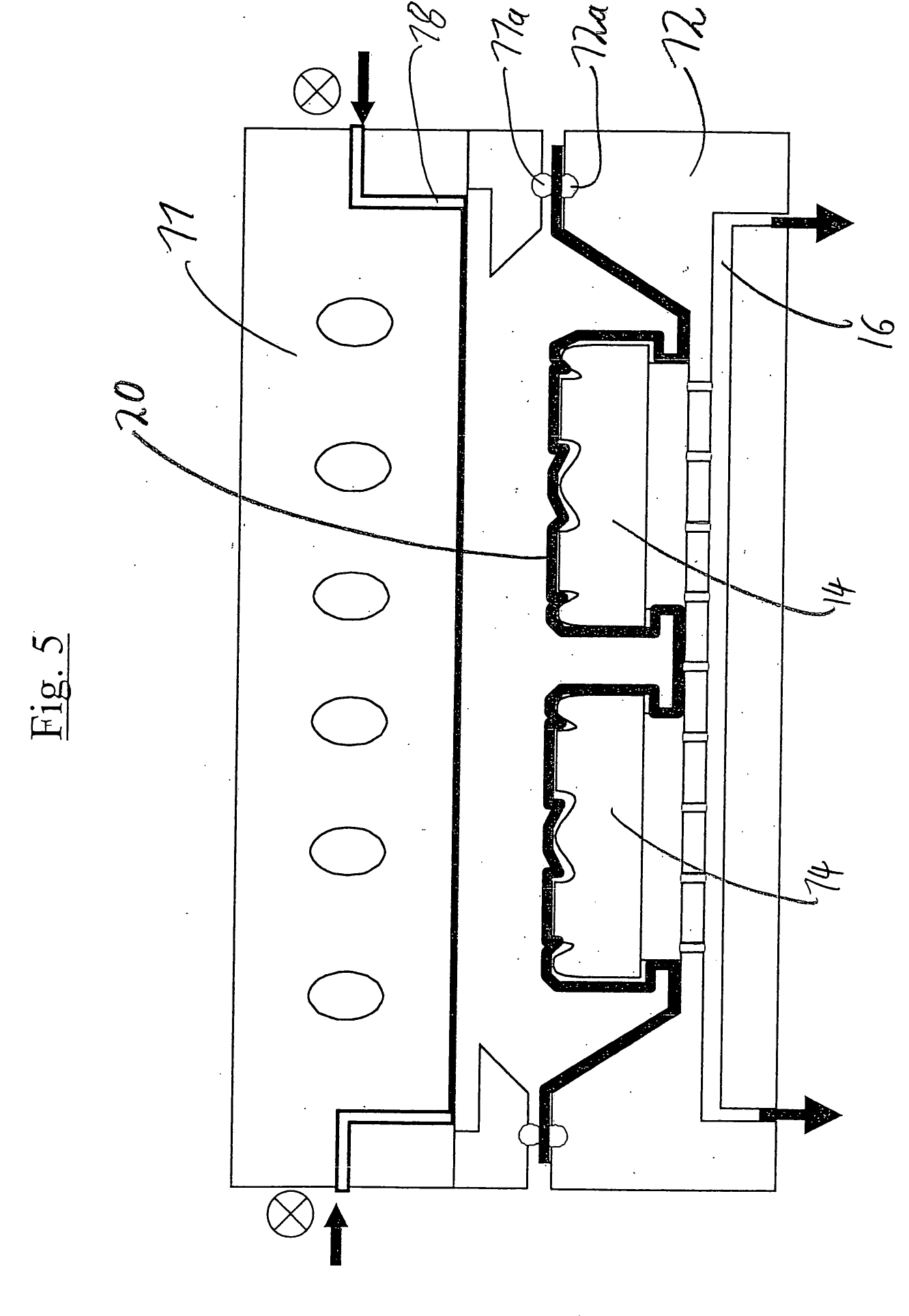

FIG. 5 shows the subsequent processing stage. It can follow immediately to the lifting of the film 20 off the work pieces; however, the film 20 can also be allowed to briefly rest on the work pieces 14 after the lifting process and before the deformation process begins according to FIG. 5. The deformation process itself occurs according to the state of prior art, namely by a strong pressure impingement of the upper channel system 18 and/or an application with vacuum via the lower channel system 16 causing the film to be pressed into the spaces between the work pieces 14 and to overall contact the peripheral lateral side surfaces of the work pieces.

Subsequently, the work pieces are removed from the press including the film connecting them and are separated from one another by cutting them out of the film in fashions known.

With regard to lifting the film 20 off the work pieces 14, as has been mentioned, the opposite kinematic process is certainly included as well, i.e. the film maintaining its position instead and the work pieces being lowered. A combination of the two motion processes is possible as well. It is merely required that the contact of the film to the surfaces of the work pieces at the end of the heating process is briefly interrupted.

1. A method for a multi-lateral coating of work pieces (14) with a film (20) so that upper sides and lateral side surfaces are coated, comprising:
supporting the work pieces (14) on a lower press component (12);
subsequently inserting the film (20) above the work pieces (14) into a press gap;
closing the press being closed, and heating the film from above;
after the film (20) has reached the predetermined temperature range and prior to adhesion, at least partially lifting the film off the upper sides of the work pieces and holding the film suspended; and
pressing the film not only to the upper side but also to the lateral side surfaces of the inserted work pieces (14) by pressure from above and/or a vacuum from below, adhering the film to the upper side and the lateral side surfaces of the inserted work pieces (14).

2. A method according to claim 1, wherein the at least partially lifting the film (20) is caused by vacuum from below and/or a pressure from above.

3. A method according to claim 1, wherein the at least partially lifting the film (20) occurs for a time of at least 3 seconds.

4. A method according to claim 1, wherein the at least partially lifting the film occurs for a time ranging from approximately 4 seconds to approximately 20 seconds.

5. A method according to claim 1, wherein hot air is blown in from below for the at least partially lifting the film (20).

6. A method according to claim 1, wherein the film (20) remains at a distance from the upper heating device even in a lifted state.

7. A method according to claim 1, wherein the at least partially lifting the film (20) occurs immediately before adhesion of the film to the upper side and the lateral side surfaces of the work pieces.

8. A method according to claim 1, wherein prior to the at least partially lifting the film, the film (20) is pressed precisely against the upper sides of the work pieces.

9. A method according to claim 1, wherein the at least partially lifting the film occurs for a time ranging from approximately 5 seconds to approximately 10 seconds.
